(19) United States
(12) Patent Application Publication
(10) Pub. No.: US 2008/0234003 A1
(43) Pub. Date: Sep. 25, 2008

(54) APPARATUS AND METHOD FOR CANCELLING FREQUENCY OFFSET INTERFERENCE IN A BROADBAND WIRELESS COMMUNICATION SYSTEM

(75) Inventors: Elisabeth de Carvalho, Aalborg (DK); Hiroyuki Yomo, Aalborg (DK); Kathiravetpillai Sivanesan, Suwon-si (KR); Eun-Taek Lim, Suwon-si (KR); David Mazzarese, Suwon-si (KR); Young-Kwon Cho, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/053,042

(22) Filed: Mar. 21, 2008

(30) Foreign Application Priority Data
Mar. 21, 2007 (KR) 2007-0027498

(51) Int. Cl. H04M 1/00

(52) U.S. Cl. 455/561

(57) ABSTRACT

An apparatus and method for detecting a signal in a broadband wireless communication system are provided. In a Base Station, an offset estimator estimates frequency offsets of a signal received from each of a plurality of Mobile Stations (MSs), a channel estimator estimates a channel matrix having channel coefficients of subcarriers as elements, for each MS, a modeler models the received signals using the frequency offsets of the MSs and the channel matrices of the MSs, and a detector detects signals transmitted from the MSs using the modeled received signals.

### PRIORITY

This application claims priority under 35 U.S.C. §119(a) to a Korean Patent Application filed in the Korean Intellectual Property Office on Mar. 21, 2007 and assigned Serial No. 2007-27498, the entire disclosure of which is incorporated herein by reference.

### BACKGROUND OF THE INVENTION

1. Field of the Invention

The present invention generally relates to a broadband wireless communication system, and in particular, to an apparatus and method for canceling interference caused by different frequency offsets between Mobile Stations (MSs) in a Base Station (BS) that receives signals from a plurality of MSs in a broadband wireless communication system.

2. Description of the Related Art

Provisioning of services with diverse Quality of Service (QoS) requirements at or above 100 Mbps to users is an active study area for a future-generation communication system called the 4^{th} Generation (4G) communication system. In particular, active research on provisioning of high-speed service by ensuring mobility and QoS to a Broadband Wireless Access (BWA) communication system such as Wireless Local Area Network (WLAN) and Wireless Metropolitan Area Network (WMAN) is on-going.

An example of the 4G communication system is Institute of Electrical and Electronics Engineers (IEEE) 802.16. The IEEE 802.16 communication system is implemented by applying Orthogonal Frequency Division Multiplexing (OFDM)/Orthogonal Frequency Division Multiple Access (OFDMA) to physical channels in order to support a broadband transmission network.

In the OFDM/OFDMA wireless communication system, a BS transmits signals to a plurality of MSs in an OFDM symbol by Inverse Fast Fourier Transform (IFFT). In other words, one OFDM symbol from the BS includes signals directed to a plurality of MSs. Meanwhile, one OFDM symbol received at the BS is the sum of signals transmitted from a plurality of MSs. Although the MSs transmit their signals on different subcarriers, the signals have different frequency offsets because the MSs are placed in different channel statuses. As a result, inter-MS interference, i.e. inter-subcarrier interference, exists in the OFDM symbol that the BS receives, thus degrading the reception performance of the BS.

### SUMMARY OF THE INVENTION

An object of the present invention is to solve at least the above-mentioned problems and/or disadvantages and to provide at least the advantages described below. Accordingly, an aspect of the present invention is to provide an apparatus and method for preventing the degradation of reception performance caused by different frequency offsets in a Base Station (BS) in a broadband wireless communication system.

Another aspect of the present invention provides an apparatus and method for canceling frequency offset interference of a received signal in a broadband wireless communication system.

A further aspect of the present invention provides an apparatus and method for canceling frequency offset interference using subcarrier signals obtained by compensating for the frequency offsets of each Mobile Station (MS) in a broadband wireless communication system.

In accordance with an aspect of the present invention, there is provided an apparatus of a BS in a broadband wireless communication system, in which an offset estimator estimates frequency offsets of a signal received from each of a plurality of MSs, a channel estimator estimates a channel matrix having channel coefficients of subcarriers as elements, for the each MS, a modeler models the received signals using the frequency offsets of the MSs and the channel matrices of the MSs, and a detector detects signals transmitted from the MSs using the modeled received signals.

In accordance with another aspect of the present invention, there is provided a method for detecting a signal in a BS in a broadband wireless communication system, in which frequency offsets of a signal received from each of a plurality of MSs are estimated, a channel matrix having channel coefficients of subcarriers as elements is estimated for each MS, the received signals are modeled using the frequency offsets of the MSs and the channel matrices of the MSs, and signals transmitted from the MSs are detected using the modeled received signals.

### BRIEF DESCRIPTION OF THE DRAWINGS

The above and other objects, features and advantages of the present invention will become more apparent from the following detailed description when taken in conjunction with the accompanying drawings, in which:

FIGS. 1A and 1B illustrate examples of using subcarriers in a broadband wireless communication system;

FIG. 2 is a block diagram of a BS in a broadband wireless communication system according to the present invention;

FIG. 3 is a flowchart of an operation for canceling frequency offset interference in the BS in the broadband wireless communication system according to the present invention;

FIGS. 4A through 4D are graphic data illustrating the performance of the present invention in a Spatial Division Multiple Access (SDMA) system; and

FIGS. 5A and 5B are graphic data illustrating the performance of the present invention in a Frequency Division Multiple Access (FDMA) system.

### DETAILED DESCRIPTION OF THE EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides a technique for canceling inter-subcarrier interference from a received signal in a broadband wireless communication system. While the exemplary embodiments of the present invention are described in the context of an Orthogonal Frequency Division Multiplexing (OFDM) wireless communication system, it is to be clearly understood that they are also applicable to other wireless communication systems using multi-carrier multiple access schemes.

A description will first be made of variables and functions used for describing the present invention.

Herein, a channel value is a digital channel impulse response sampled at a sampling rate of Ts, expressed by Equation (1).

[h₀h₁ . . . h_{L-1}] (1)

where hₖ denotes a k^{th} sample value of the channel impulse response and L denotes the number of samples in the channel impulse response.

An OFDM symbol received from n Mobile Station (MS) is represented in the time domain by Equation (2).

y(t)=[h*x](t)e^{j2πδf}+n(t) (2)

where y(t) denotes the received OFDM symbol, h denotes the channel impulse response, x denotes a transmitted OFDM symbol, * denotes convolution operator, δf denotes a frequency offset, and n(t) denotes additive noise.

A signal received on one of a plurality of subcarriers included in the OFDM symbol is expressed by Equation (3).

Y(k)=α(0, δf)H(k)X(k)+ICI( H̅(k), X̅(k),δf)+N(k) (3)

where Y(k) denotes the received signal on subcarrier k, δf denotes a frequency offset, α(0,δf) denotes a gain coefficient caused by the frequency offset, H(k) denotes a channel coefficient for subcarrier k, X(k) denotes a transmitted signal on subcarrier k, ICI( H̅(k), X̅(k),δf) denotes interference from subcarriers other than subcarrier k, and N(k) denotes additive noise. The variables described in Equation (3) are frequency-domain representations. α(0,δf) and ICI( H̅(k), X̅(k),δf) are computed by Equation (4).

$$\begin{matrix}α ( n , δ f ) = exp ( j2πδ f \frac{{sN}_{s} + {N}_{g}}{{N}_{FFT}} ) \cdot exp ( j2π ( n + δ f ) \frac{{N}_{FFT} - 1}{{N}_{FFT}} ) \cdot \\ \frac{sin π ( n + δ f )}{N sin π \frac{n + δ f}{{N}_{FFT}}} ICI ( \overline{H} ( k ) , \overline{X} ( k ) δ f ) \\ = {\sum }_{{k}^{′} \neq k} α ( k - {k}^{′} , δ f ) H ( {k}^{′} ) X ( {k}^{′} )\end{matrix} \qquad ( 4 )$$

where δf denotes a frequency offset, α(n,δf) denotes an offset coefficient when the frequency offset between two subcarriers is δf and the difference between the indexes of the two subcarriers is n, s denotes an OFDM symbol index, Nₛ denotes an OFDM symbol length, N_{g} denotes a guard interval length, N_{FFT} denotes a Fast Fourier Transform (FFT) size, k denotes a subcarrier index, H̅(k) denotes channel coefficients for subcarriers other than subcarrier k, and X̅(k) denotes transmitted signals on the subcarriers other than subcarrier k. If n is 0, α(n,δf) is a gain coefficient and if n is not 0, α(n,δf) is an interference coefficient.

The received signals on all subcarriers of the OFDM symbols are represented by Equation (5).

Y=[Y^{T}(0) . . . Y^{T}(K−1)]^{T}=A(δf)HX+N (5)

where Y denotes the received signals on all subcarriers of the OFDM symbol, Y(k) denotes a received signal on subcarrier k, K denotes the number of subcarriers, δf denotes frequency offsets, H denotes channel coefficients for all the subcarriers, X denotes signals transmitted on all the subcarriers, N denotes additive noise, and A(δf) denotes a matrix of gain coefficients and interference coefficients caused by the frequency offsets. A(δf) is a Toeplitz matrix with all diagonal entries equal. The first row and column of A(δf) are given by Equation (6).

1st row:[α(0,δf)α(1,δf) . . . α(K−1,δf)]

1st column:[α(0,δf)α(−1,δf) . . . α(−K+1,δf)]^{T} (6)

where δf denotes a frequency offset, α(n,δf) denotes the coefficient calculated by equation (4), and K denotes the number of subcarriers.

In Equation (5), H is

$$H = [ \begin{matrix}H ( 0 ) & 0 & ⋯ & 0 \\ 0 & H ( 1 ) & 0 & ⋮ \\ ⋮ & ⋮ & ⋮ & 0 \\ 0 & ⋯ & 0 & H ( K - 1 )\end{matrix} ] \qquad ( 7 )$$

where H denotes a channel coefficient matrix, H(k) denotes a channel coefficient for subcarrier k, and K denotes the number of subcarriers.

The received signals of all the subcarriers in the OFDM symbol described in Equation (5) are represented by Equation (8) as a normal signal and an interference signal separately.

Y=α(0,δf)HX+Ā(δf)HX+N (8)

where Y denotes the received signals on all the subcarriers of the OFDM symbol, H denotes the channel coefficients for all the subcarriers, X denotes the signals transmitted on all the subcarriers, N denotes additive noise, α(0,δf) denotes gain coefficients caused by frequency offsets, calculated by Equation (4), and Ā(δf) denotes interference coefficients calculated by Equation (9). α(0,δf)HX is a coefficient for the normal signal and Ā(δf)HX is a coefficient for the interference signal.

Ā(δf)=A(δf)−α(0,δf)I (9)

where Ā(δf) denotes the interference coefficients, A(δf) denotes the matrix of gain coefficients and interference coefficients, α(0,δf) denotes the gain coefficients caused by the frequency offsets, and I denotes an identity matrix.

Based on the above-described system and environment model, the present invention is implemented, taking into account two cases.

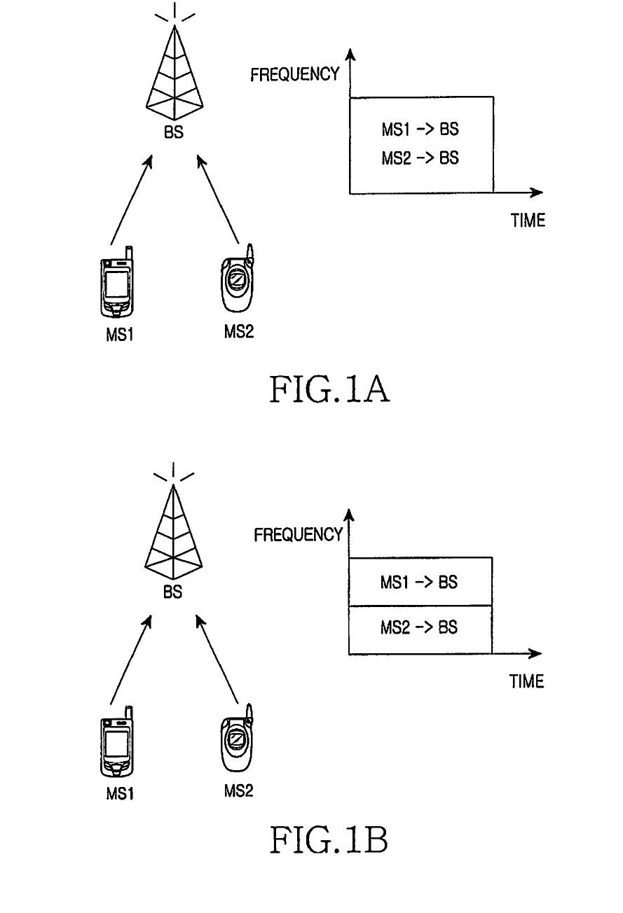

One case is spatial multiple access in which a plurality of MSs uses the same radio resources, as illustrated in FIG. 1A. The other case is frequency multiple access in which a plurality of MSs uses radio resources in different frequency bands, as illustrated in FIG. 1B. For convenience sake, the present invention will be described on the assumption of communications between a Base Station (BS) with two receive antennas and two MSs each having a single transmit antenna.

In the first case illustrated in FIG. 1A, the BS receives signals from the two MSs, MS1 and MS2. The BS acquires time synchronization to the MSs and obtains the received signals Y₁ and Y₂ from the MSs by Fast Fourier Transform (FFT). Y₁ and Y₂ are expressed by Equation (10).

Y₁=H₁X₁+A(δf₂−δf₁)H₂X₂+n

Y₂=H₂X₂+A(δf₁−δf₂)H₁X₁+A(δf₁−δf₂)n (10)

where Yₘ denotes a signal received from MS m, Hₘ denotes a channel coefficient for MS m, Xₘ denotes a transmitted signal from MS m, A(δfₘ−δfₙ) denotes the interference coefficient of the transmitted signal of MS m that interferes with a transmitted signal of MS n, δfₘ denotes frequency offsets of MS m, and n denotes additive noise.

The terms of equation (10) are re-defined by Equation (11).

$$Y = H [ \begin{matrix}{X}_{1} \\ {X}_{2}\end{matrix} ] + N \\ Y = [ \begin{matrix}{Y}_{1} \\ {Y}_{2}\end{matrix} ] \\ H = [ \begin{matrix}{H}_{1} & A ( δ {f}_{2} - δ {f}_{1} ) {H}_{2} \\ A ( δ {f}_{1} - δ {f}_{2} ) {H}_{1} & {H}_{2}\end{matrix} ] \\ N = {[ \begin{matrix}I \\ A ( δ {f}_{1} - δ {f}_{2} )\end{matrix} ]}^{n} \qquad ( 11 )$$

where Yₘ denotes the signal received from MS m, Hₘ denotes the channel coefficient for MS m, Xₘ denotes the transmitted signal from MS m, A(δfₘ−δfₙ) denotes the interference coefficient of the transmitted signal of MS m that interferes with the transmitted signal of MS n, δfₘ denotes the frequency offsets of MS m, and n denotes additive noise.

For any subcarrier, Equations (10) and (11) are expressed by Equation (12).

$$\begin{matrix}Y ( k ) = [ \begin{matrix}{Y}_{1} ( k ) \\ {Y}_{2} ( k )\end{matrix} ] \\ = [ \begin{matrix}{H}_{1} ( k ) & α ( 0 , δ f ) {H}_{2} ( k ) \\ α ( 0 , δ {f}_{1} - δ {f}_{2} ) {H}_{1} ( k ) & {H}_{2} ( k )\end{matrix} ] [ \begin{matrix}{X}_{1} ( k ) \\ {X}_{2} ( k )\end{matrix} ] + \\ [ \begin{matrix}{\overline{A}}_{k} ( δ {f}_{2} - δ {f}_{1} ) {H}_{2} {X}_{2} \\ {\overline{A}}_{k} ( δ {f}_{1} - δ {f}_{2} ) {H}_{1} {X}_{1}\end{matrix} ] + N ( k )\end{matrix} \qquad ( 12 )$$

where Yₘ(k) denotes a signal received on subcarrier k from MS m, Hₘ(k) denotes a channel coefficient of subcarrier k for MS m, Xₘ(k) denotes a signal transmitted on subcarrier k from MS m, Āₖ(δfₘ−δfₙ) denotes the interference coefficient of subcarriers other than subcarrier k from MS m that interferes with the transmitted signal of MS n, δfₘ denotes the frequency offsets of MS m, and N(k) denotes additive noise. α(0,δf) is computed by Equation (4) and Āₖ(δfₘ−δfₙ) is a k^{th} row of the Toeplitz matrix having rows and columns described in Equation (6).

Part of the terms of Equation (12) are given by Equation (13).

$$[ \begin{matrix}{\overline{A}}_{k} ( δ {f}_{2} - δ {f}_{1} ) {H}_{2} ( 0 ) {X}_{2} \\ {\overline{A}}_{k} ( δ {f}_{1} - δ {f}_{2} ) {H}_{1} ( 0 ) {X}_{1}\end{matrix} ] + N ( k ) = I ( k ) + N ( k ) \qquad ( 13 )$$

where Hₘ(k) denotes the channel coefficient of subcarrier k for MS m, Xₘ denotes the signal transmitted from MS m, and Āₖ(δfₘ−δfₙ) denotes the interference coefficient of subcarriers other than subcarrier k from MS m that interferes with the transmitted signal of MS n. From the perspective of the system, the terms of Equation (13) are all considered noise.

If the noise I(k)+N(k) of the received signals Y₁ and Y₂ is not decorrelated or partially decorrelated, which means that inverse matrices exists for received signal matrices, a set of two equations are obtained for the respective received signals Y₁ and Y₂. The solution of the equation set is received signals from which frequency offset interference has been cancelled. Hence, the BS can achieve the frequency offset interference-free received signals by computing the solution of the equation set.

When each MS uses an Adaptive Modulation and Coding (AMC) channel, the channel coefficient is equal over all subcarriers. In this case, Equation (12) is given by Equation (14).

$$\begin{matrix}Y ( k ) = [ \begin{matrix}{Y}_{1} ( k ) \\ {Y}_{2} ( k )\end{matrix} ] \\ = [ \begin{matrix}{H}_{1} & α ( 0 , δ f ) {H}_{2} \\ α ( 0 , δ {f}_{1} - δ {f}_{2} ) {H}_{1} & {H}_{2}\end{matrix} ] [ \begin{matrix}{X}_{1} ( k ) \\ {X}_{2} ( k )\end{matrix} ] + \\ [ \begin{matrix}{\overline{A}}_{k} ( δ {f}_{2} - δ {f}_{1} ) {H}_{2} {X}_{2} \\ {\overline{A}}_{k} ( δ {f}_{1} - δ {f}_{2} ) {H}_{1} {X}_{1}\end{matrix} ] + N ( k ) \\ = [ \begin{matrix}{H}_{1} {X}_{1} ( k ) & {H}_{2} {A}_{k} ( δ {f}_{2} - δ {f}_{1} ) {X}_{2} \\ {H}_{1} {A}_{k} ( δ {f}_{1} - δ {f}_{2} ) {X}_{1} & {H}_{2} {X}_{2} ( k )\end{matrix} ] + N ( k )\end{matrix} \qquad ( 14 )$$

where Yₘ(k) denotes the signal received on subcarrier k from MS m, Hₘ denotes the channel coefficient for MS m, Xₘ(k) denotes the signal transmitted on subcarrier k from MS m, α(0,δf) denotes a gain coefficient, Āₖ(δfₘ−δfₙ) denotes the interference coefficient of subcarriers other than subcarrier k from MS m that interferes with the transmitted signal of MS n, δfₘ denotes the frequency offsets of MS m, N(k) denotes additive noise on subcarrier k, and A(δfₘ−δfₙ) denotes the interference coefficient of MS m that interferes with MS n over all subcarriers. δ(0,δf) is computed by Equation (4) and Āₖ(δfₘ−δfₙ) is a k^{th} row of the matrix formed by Equation (6).

Among the received signals described in Equation (14), the received signal from MS1 is expressed for each antenna by Equation (15).

Y_{1.A1}(k)=H_{1.A1}X₁(k)+H_{2.A1}Aₖ(δf₂−δf₁)X₂+N_{1.A1}(k)

Y_{1.A2}(k)=H_{1.A2}X₁(k)+H_{2.A2}Aₖ(δf₂−δf₁)X₂+N_{1.A2}(k) (15)

where Y_{m.An} denotes the signal received from MS m through antenna n, H_{m.An} denotes a channel coefficient between antenna n and MS m, Xₘ(k) denotes the signal transmitted on subcarrier k from MS m, A(δfₘ−δfₙ) denotes the interference coefficient of MS m that interferes with MS n over all subcarriers, and N_{m.An} denotes additive noise between antenna n and MS m.

Referring to Equation (15), when A(δfₘ−δfₙ) is equal for every antenna, an interference-cancelled received signal from MS 1 is easily obtained. An equation set for obtaining the interference-cancelled received signal from MS 1 can be simplified to the single equation, Equation (16).

$$[ \begin{matrix}{Y}_{1. A 1} ( k ) \\ {Y}_{1. A 2} ( k )\end{matrix} ] = [ \begin{matrix}{H}_{1. A 1} & {H}_{1. A 2} \\ {H}_{1. A 1} & {H}_{1. A 2}\end{matrix} ] [ \begin{matrix}{X}_{1} ( k ) \\ {A}_{k} ( δ {f}_{2} - δ {f}_{1} ) {X}_{2}\end{matrix} ] + [ \begin{matrix}{N}_{1. A 1} ( k ) \\ {N}_{1. A 2} ( k )\end{matrix} ] \qquad ( 16 )$$

where Y_{m.An} denotes the signal received from MS m through antenna n, H_{m.An} denotes the channel coefficient between antenna n and MS m, Xₘ(k) denotes the signal transmitted on subcarrier k from MS m, A(δfₘ−δfₙ) denotes the interference coefficient of MS m that interferes with MS n, and N_{m.An} denotes the additive noise between antenna n and MS m.

In the second case illustrated in FIG. 1B, the BS receives signals from the two MSs, MS1 and MS2. The BS compensates for the frequency offsets of the MSs and obtains the received signals Y₁ and Y₂ from the MSs by FFT. Similarly to the equation developed for the case illustrated in FIG. 1A, Y₁ and Y₂ are expressed by Equation (17).

$$Y = [ \begin{matrix}{H}_{1} & {A}_{2} ( δ {f}_{2} - δ {f}_{1} ) {H}_{2} \\ {A}_{1} ( δ {f}_{1} - δ {f}_{2} ) {H}_{1} & {H}_{2}\end{matrix} ] [ \begin{matrix}{X}_{1} \\ {X}_{2}\end{matrix} ] + N \qquad ( 17 )$$

where Hₘ denotes a channel coefficient for MS m, A(δfₘ−δfₙ) denotes an interference coefficient matrix for interference that MS m interferes with MS n, Xₘ denotes a transmitted signal from MS m, and N denotes additive noise.

For any subcarrier, equation (17) is expressed by Equation (18).

$$Y = [ \begin{matrix}{H}_{1} ( k ) \\ α ( 0 , δ {f}_{1} - δ {f}_{2} ) {H}_{1} ( k )\end{matrix} ] {X}_{1} ( k ) + [ \begin{matrix}{\overline{A}}_{2 , k} ( δ {f}_{2} - δ {f}_{1} ) {H}_{2} {X}_{2} \\ {\overline{A}}_{1 , k} ( δ {f}_{1} - δ {f}_{2} ) {H}_{2} {X}_{1}\end{matrix} ] + N ( k ) \qquad ( 18 )$$

where Hₘ(k) denotes a channel coefficient of subcarrier k for MS m, α(0,δfₘ−δfₙ) denotes the coefficient of interference from subcarrier k that MS m causes to MS n, Āₖ(δfₘ−δfₙ) denotes the coefficient of interference from subcarriers other than subcarrier k that MS m causes to MS n, δfₘ denotes the frequency offsets of MS m, Hₘ denotes a channel coefficient for MS m, Xₘ denotes the signal transmitted from MS m, and N denotes additive noise.

Now a description will be made of the configuration and operation of the BS for canceling frequency offset interference based on the above-described received signal model.

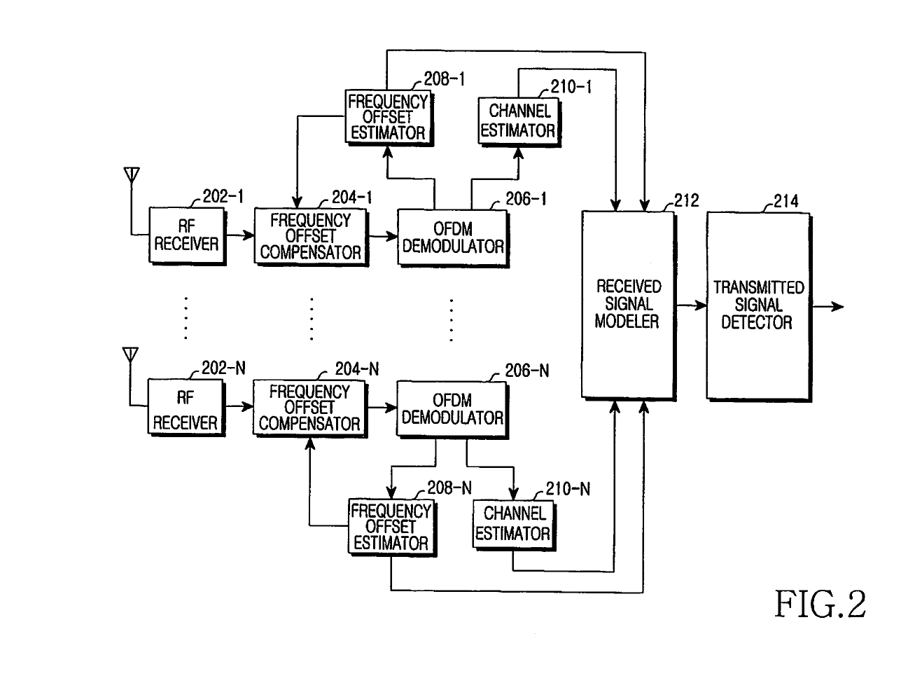

FIG. 2 is a block diagram of a BS in a broadband wireless communication system according to the present invention. In the illustrated case of FIG. 2, the BS communicates with two MSs on the uplink. With a similar configuration, the BS can conduct uplink communication with three or more MSs.

Referring to FIG. 2, the BS includes a plurality of Radio Frequency (RF) receivers 202-1 to 202-N, a plurality of frequency offset compensators 204-1 to 204-N, a plurality of OFDM demodulators 206-1 to 206-N, a plurality of frequency offset estimators 208-1 to 208-N, a plurality of channel estimators 210-1 to 210-N, a received signal modeler 212, and a transmitted signal detector 214.

Each of the RF receivers 202-1 to 202-N down converts an RF signal received through an antenna corresponding to the RF receiver to a baseband signal. Each of the frequency offset compensators 204-1 to 204-N compensates for the frequency offsets of a signal received from an RF receiver corresponding to the frequency offset compensator. When a plurality of MSs shares the entire frequency band in spatial multiple access as illustrated in FIG. 1A, each of the frequency offset compensators 204-1 to 204-N compensates a received signal for the frequency offsets of an MS corresponding to a predetermined antenna. On the other hand, when a plurality of MSs operates in frequency multiple access as illustrated in FIG. 1B, each of the frequency offset compensators 204-1 to 204-N compensates a received signal for the frequency offsets of the MSs. For example, when the BS receives signals from MS1 and MS2, each frequency offset compensator compensates a received signal according to the frequency offsets of the MS1 and MS2.

Each of the OFDM demodulators 206-1 to 206-N divides a signal received from a frequency offset compensator corresponding to the OFDM demodulator on an OFDM symbol basis, removes a Cyclic Prefix (CP) from an OFDM symbol, and converts the time signal to a subcarrier signal by FFT. The frequency offset estimators 208-1 to 208-N estimate the frequency offsets of the MSs using pilot signals among the subcarrier signals. The channel estimators 210-1 to 210-N estimate channel matrices, each having the channel coefficients of subcarriers of an MS as elements, using the pilot signals.

The received signal modeler 212 models the received signals using the frequency offsets of the MSs received from the frequency offset estimators 208-1 to 208-N and the channel matrices of the MSs received from the channel estimators 210-1 to 210-N. The received signal modeler 212 calculates frequency offsets-incurred offset coefficient matrices using the frequency offsets of the MSs. The offset coefficient matrices are Toeplitz matrices having elements described by Equation (6), each element being computed by Equation (4). The received signal modeler 212 forms an effective channel matrix between transmitted signals and the received signals, including the offset coefficient matrices and the channel matrices, thus models the received signals. For example, if the BS receives signals from two MSs, the received signals are modeled to Equation (17).

The transmitted signal detector 214 detects the transmitted signals. In accordance with an exemplary embodiment of the present invention, the transmitted signal detector 214 calculates the inverse matrix of the effective channel matrix and multiplies the inverse matrix by the received signals, thereby detects the transmitted signals. For the signal detection, the transmitted signal detector 214 adopts Successive Interference Cancellation (SIC). If the transmitted signal detector 214 detects signals transmitted from MS1 and MS2 by SIC, it first detects the transmitted signal of MS1 on the assumption of no interference, cancels interference to the transmitted signal of MS2 using the transmitted signal of MS1, and then detects the transmitted signal of MS1 by canceling interference to the transmitted signal of MS1 using the transmitted signal of MS2. The transmitted signal detector 214 repeats the interference cancellation and detection until an optimum detection value is obtained.

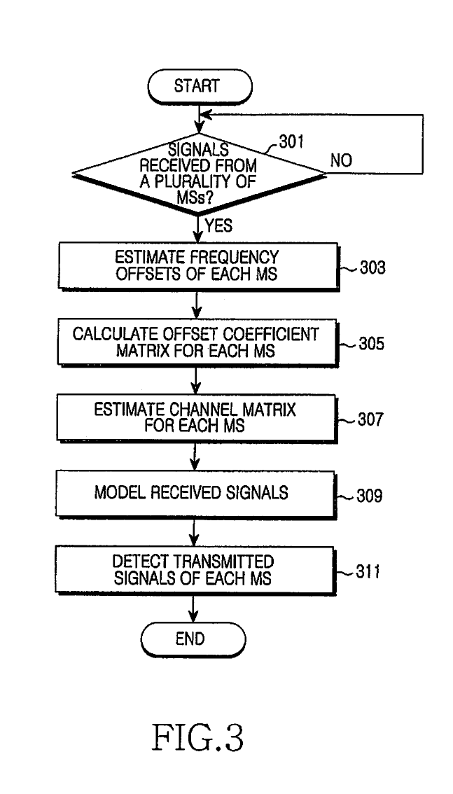

FIG. 3 is a flowchart of an operation for detecting a transmitted signal in the BS in the broadband wireless communication system according to the present invention. Referring to FIG. 3, the BS monitors reception of signals from a plurality of MSs in step 301. The BS may receive signals from the MSs in the same frequency band by spatial multiple access as illustrated in FIG. 1A or in different frequency bands by frequency multiple access as illustrated in FIG. 1B.

Upon receipt of signals from the MSs, the BS estimates the frequency offsets of each of the MSs using pilot signals included in the signal received from the MS in step 303.

In step 305, the BS calculates a frequency offset-incurred offset coefficient matrix using the frequency offsets of the MS. The offset coefficient matrix is a Toeplitz matrix with elements described in Equation (6), each element being computed by Equation (4).

The BS estimates a channel matrix with the channel coefficients of respective subcarriers as elements for the MS in step 307. Herein, the frequency offsets are estimated using pilot signals included in the signal received from the MS.

In step 309, the BS models the signals received from the MSs in step 301. That is, the BS models the received signals by forming an effective channel matrix between transmitted signals and the received signals, including the offset coefficient matrices and the channel matrices. For example, if the BS receives signals from two MSs, the received signals are modeled to Equation (17).

In step 311, the BS detects the transmitted signal of each MS using the modeled received signal. In accordance with an exemplary embodiment of the present invention, the BS calculates the inverse matrix of the effective channel matrix and multiplies the inverse matrix by the received signals, thereby detects the transmitted signals. For the signal detection, the BS adopts SIC. When the BS detects signals transmitted from MS1 and MS2 by SIC, it first detects the transmitted signal of MS1 on the assumption of no interference, cancels interference to the transmitted signal of MS2 using the transmitted signal of MS1, and then detects the transmitted signal of MS1 by canceling interference to the transmitted signal of MS1 using the transmitted signal of MS2. The BS repeats the interference cancellation and detection until an optimum detection value is obtained.

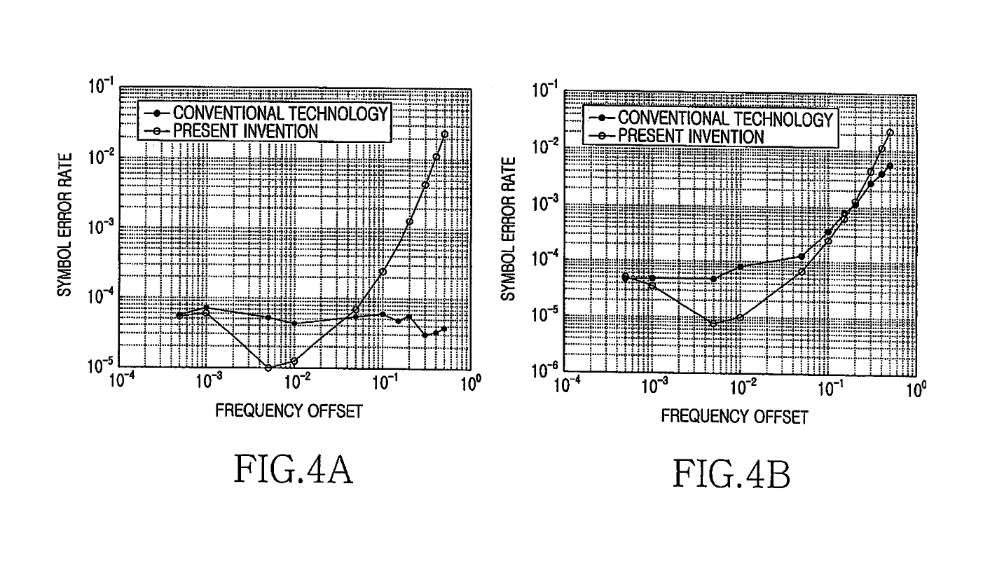

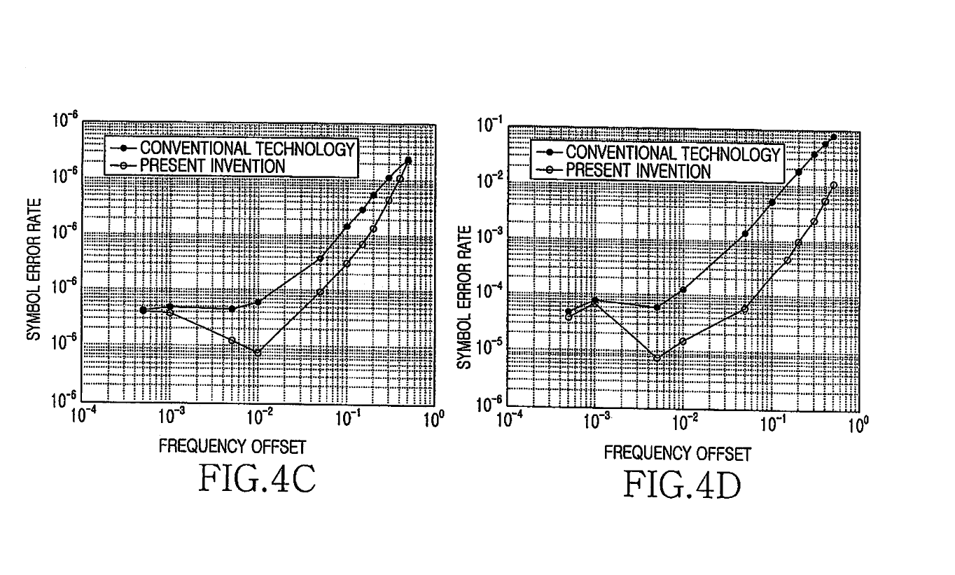

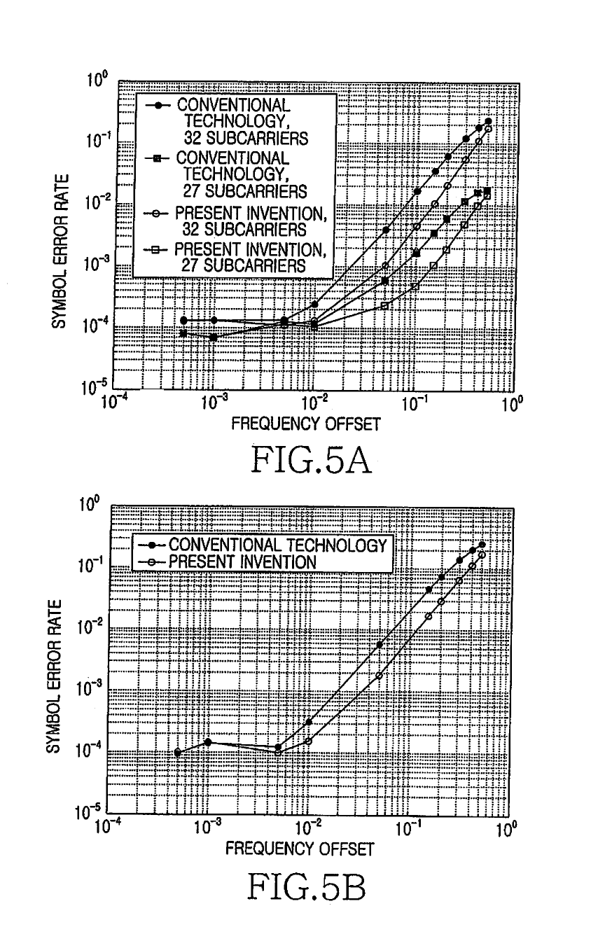

FIGS. 4A through 5B illustrate the performances of the present invention. FIGS. 4A through 4D illustrate simulated results of the present invention in a Spatial Division Multiple Access (SDMA) system and FIGS. 5A and 5B illustrate simulated results of the present invention in a Frequency Division Multiple Access (FDMA) system. Simulations were performed under the conditions of two MSs, 64 subcarriers, and Quadrature Phase Shift Keying (QPSK), on the assumption of perfect knowledge of frequency offsets and channel values. The graphic data of FIGS. 4A through 5B illustrate symbol error rates versus frequency offsets. The horizontal axis represents frequency offset and the vertical axis represents symbol error rate.

FIG. 4A shows graphic data where the channel coefficients are equal to the entire frequency band. In this case, the present invention has lower error rates than conventional technology for very smaller frequency offsets. The conventional technology is an interference cancellation scheme using only a signal from an intended MS.

FIG. 4B shows graphic data where the channel coefficient of each subcarrier follows a Gaussian distribution having a variance of 0.01 over the entire frequency band. In this case, the present invention has lower error rates than the conventional technology for frequency offsets except for some large frequency offsets.

FIG. 4C shows graphic data where the channel coefficient of each subcarrier follows a Gaussian distribution having a variance of 0.05. In this case, the present invention has lower error rates than the conventional technology for all frequency offsets.

FIG. 4D shows graphic data where the MSs share a half of the entire frequency band and a third MS uses the other half The signal of the third MS is handled as noise. In this case, the present invention has much lower error rates than the conventional technology.

FIG. 5A shows graphic data where each MSs uses an equal number of successive subcarriers, specifically 32 and 27. In this case, the conventional technology performs as the present invention, for small frequency offsets, but the present invention has lower error rates than the conventional technology, as the frequency offset increases.

FIG. 5B shows graphic data where the MSs use equal halves of the entire frequency band, and each half includes non-successive subcarriers. In this case, the conventional technology performs as the present invention, for small frequency offsets, but the present invention has lower error rates than the conventional technology, as the frequency offset increases.

As is apparent from the above description, the present invention cancels frequency offset interference using subcarrier signals which are compensated for frequency offsets for each MS in a broadband wireless communication system. The effective frequency offset interference cancellation increases the reception performance of a BS.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. An apparatus of a Base Station (BS) in a wireless communication system, comprising:
an offset estimator for estimating frequency offsets of a signal received from a plurality of Mobile Stations (MSs);
a channel estimator for estimating a channel matrix having channel coefficients of subcarriers, for each MS;
a modeler for modeling the received signals using the frequency offsets of the MSs and the channel matrices of the MSs; and
a detector for detecting signals transmitted from the MSs using the modeled received signals.

2. The apparatus of claim 1, wherein the modeler models the received signals by generating frequency offset-incurred offset coefficient matrices using the frequency offsets of the MSs and forming an effective channel matrix having the offset coefficient matrices and the channel matrices of the MSs.

3. The apparatus of claim 2, wherein the modeler calculates frequency offset-caused gain coefficients of normal signals on subcarriers and frequency offset-caused interference coefficients of interference signals on subcarriers, for each MS and generates an offset coefficient matrix having the gain coefficients and the interference coefficients, for each MS.

4. The apparatus of claim 3, wherein the modeler computes the gain coefficients and the interference coefficients by
$$α ( n , δ f ) = exp ( j2πδ f \frac{ {sN}_{s} + {N}_{g}}{{N}_{FFT}} ) \cdot exp ( j2π ( n + δ f ) \frac{{N}_{FFT} - 1}{{N}_{FFT}} ) \cdot \frac{sin π ( n + δ f )}{N sin π \frac{n + δ f}{{N}_{FFT}}}$$
where δf denotes a frequency offset, α(n,δf) denotes an offset coefficient when the frequency offset between two subcarriers is δf and the difference between the indexes of the two subcarriers is n, s denotes an Orthogonal Frequency Division Multiplexing (OFDM) symbol index, Nₛ denotes an OFDM symbol length, N_{g} denotes a guard interval length, N_{FFT} denotes a Fast Fourier Transform (FFT) size, k denotes a subcarrier index, H̅(k) denotes channel coefficients for subcarriers other than subcarrier k, and X̅(k) denotes transmitted signals on the subcarriers other than subcarrier k, wherein when n is 0, α(n,δf) is a gain coefficient and when n is not 0, α(n,δf) is an interference coefficient.

5. The apparatus of claim 4, wherein each of the offset coefficient matrices is a Toeplitz matrix with a first row and a first column given as
1st row:[α(0,δf)α(1,δf) . . . α(K−1,δf)]
1st column:[α(0,δf)α(−1,δf) . . . α(−K+1,δf)]^{T}
where α(n,δf) denotes an offset coefficient when the frequency offset between two subcarriers is δf and the difference between the indexes of the two subcarriers is n,δf denotes a frequency offset, and K denotes the number of subcarriers.

6. The apparatus of claim 5, wherein when signals are received from two MSs, the effective channel matrix is
$$Y = [ \begin{matrix}{H}_{1} & {A}_{2} ( δ {f}_{2} - δ {f}_{1} ) {H}_{2} \\ {A}_{1} ( δ {f}_{1} - δ {f}_{2} ) {H}_{1} & {H}_{2}\end{matrix} ] [ \begin{matrix}{X}_{1} \\ {X}_{2}\end{matrix} ] + N$$
where Hₘ denotes a channel matrix of an MS m, A(δfₘ−δfₙ) denotes an interference coefficient matrix for interference that MS m interferes with an MS n, Xₘ denotes a transmitted signal from the MS m, and N denotes additive noise.

7. The apparatus of claim 6, wherein the detector calculates an inverse matrix of the effective channel matrix and detects the transmitted signals of the MSs by multiplying the received signals by the inverse matrix.

8. The apparatus of claim 6, wherein the detector detects the transmitted signals of the MSs by Successive Interference Cancellation (SIC).

9. The apparatus of claim 8, wherein the detector detects the transmitted signals of the MSs by repeating detection of the transmitted signals of part of the MSs, cancellation of interference with the transmitted signals of at least one of the other MSs using the detected transmitted signals, and detection of the transmitted signal of the at least one MS.

10. A method for detecting a signal in a Base Station (BS) in a wireless communication system, comprising:
estimating frequency offsets of a signal received from a plurality of Mobile Stations (MSs);
estimating a channel matrix having channel coefficients of subcarriers, for each MS;
modeling the received signals using the frequency offsets of the MSs and the channel matrices of the MSs; and
detecting signals transmitted from the MSs using the modeled received signals.

11. The method of claim 10, wherein the modeling further comprises:
generating frequency offset-incurred offset coefficient matrices using the frequency offsets of the MSs; and
forming an effective channel matrix having the offset coefficient matrices and the channel matrices of the MSs.

12. The method of claim 11, wherein the generating frequency offset-incurred offset coefficient matrices further comprises:
calculating frequency offset-caused gain coefficients of normal signals on subcarriers and frequency offset-caused interference coefficients of interference signals on subcarriers, for each MS; and
generating an offset coefficient matrix having the gain coefficients and the interference coefficients, for each MS.

13. The method of claim 12, wherein the gain coefficients and the interference coefficients are computed by
$$α ( n , δ f ) = exp ( j2πδ f \frac{ {sN}_{s} + {N}_{g}}{{N}_{FFT}} ) \cdot exp ( j2π ( n + δ f ) \frac{{N}_{FFT} - 1}{{N}_{FFT}} ) \cdot \frac{sin π ( n + δ f )}{N sin π \frac{n + δ f}{{N}_{FFT}}}$$
where δf denotes a frequency offset, α(n,δf) denotes an offset coefficient when the frequency offset between two subcarriers is δf and the difference between the indexes of the two subcarriers is n, s denotes an Orthogonal Frequency Division Multiplexing (OFDM) symbol index, Nₛ denotes an OFDM symbol length, N_{g} denotes a guard interval length, N_{FFT} denotes a Fast Fourier Transform (FFT) size, k denotes a subcarrier index, H̅(k) denotes channel coefficients for subcarriers other than subcarrier k, and X̅(k) denotes transmitted signals on the subcarriers other than subcarrier k, wherein when n is 0, α(n,δf) is a gain coefficient and when n is not 0, α(n,δf) is an interference coefficient.

14. The method of claim 13, wherein each of the offset coefficient matrices is a Toeplitz matrix with a first row and a first column given as
1st row:[α(0,δf)α(1,δf) . . . α(K−1,δf)]
1st column:[α(0,δf)α(−1,δf) . . . α(−K+1,δf)]^{T}
where α(n,δf) denotes an offset coefficient when the frequency offset between two subcarriers is δf and the difference between the indexes of the two subcarriers is n, δf denotes a frequency offset, and K denotes the number of subcarriers.

15. The method of claim 14, wherein when signals are received from two MSs, the effective channel matrix is
$$Y = [ \begin{matrix}{H}_{1} & {A}_{2} ( δ {f}_{2} - δ {f}_{1} ) {H}_{2} \\ {A}_{1} ( δ {f}_{1} - δ {f}_{2} ) {H}_{1} & {H}_{2}\end{matrix} ] [ \begin{matrix}{X}_{1} \\ {X}_{2}\end{matrix} ] + N$$
where Hₘ denotes a channel matrix of an MS m, A(δfₘ−δfₙ) denotes an interference coefficient matrix for interference that MS m interferes with an MS n, Xₘ denotes a transmitted signal from the MS m, and N denotes additive noise.

16. The method of claim 15, wherein the detecting signals further comprises:
calculating an inverse matrix of the effective channel matrix; and
detecting the transmitted signals of the MSs by multiplying the received signals by the inverse matrix.

17. The method of claim 15, wherein the detecting signals further comprises detecting the transmitted signals of the MSs by Successive Interference Cancellation (SIC).

18. The method of claim 17, wherein the detecting signals further comprises detecting the transmitted signals of the MSs by repeating detection of the transmitted signals of part of the MSs, cancellation of interference with the transmitted signals of at least one of the other MSs using the detected transmitted signals, and detection of the transmitted signal of the at least one MS.
